(19) United States
(12) Patent Application Publication
(10) Pub. No.: US 2009/0043465 A1
(43) Pub. Date: Feb. 12, 2009

(54) Vehicle control apparatus and method

(75) Inventor: Makoto Tomita, Nagoya-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/222,173

(22) Filed: Aug. 4, 2008

(30) Foreign Application Priority Data
Aug. 10, 2007 (JP) 2007-208970

(51) Int. Cl. F16H 63/34

(52) U.S. Cl. 701/51

(57) ABSTRACT

In a case where, in order to stop a hybrid vehicle on a hill, a brake device is turned on and then the shift lever is shifted to the parking position (“P” position) to lock a parking-lock device and then the brake device is turned off and then the brake device is turned on despite that torsional torque is acting on the drive shaft, a motor generator, which is an inertial object having a large weight, is driven to rotate in a rotational direction corresponding to the direction of gradient of the road, so that the resultant rotational torque is transmitted to a sun gear, to pinions, and to a ring gear.

### INCORPORATION BY REFERENCE

The disclosure of Japanese Patent Application No. 2007-208970 filed on Aug. 10, 2007 including the specification, drawings and abstract is incorporated herein by reference in its entirety.

### BACKGROUND OF THE INVENTION

1. Field of the Invention

The invention relates to vehicle control apparatuses and vehicle control methods and more particularly relates to vehicle control apparatuses and vehicle control methods for vehicles having a parking-lock device that is operated between a lock position where it locks the drive wheels of the vehicle not to rotate and an unlock position where it allows the drive wheels to rotate.

2. Description of the Related Art

In vehicles having a drive power transmission mechanism incorporating gears meshed so as to transmit drive power of an internal combustion engine to the drive wheels of the vehicle via gears, typically, a mechanical parking-lock device is provided which locks the drive wheels by meshing particular gears in response to the shift lever being shifted to the parking position after the drive wheels of the vehicle have been stopped by the brake devices.

For example, one of such parking-lock devices is described in Japanese Patent Application Publication No. 10-278758 (JP-A-10-278758). According to this parking-lock device, three rotational elements of a drive power distribution mechanism are connected to an internal combustion engine, to a first motor generator, and to a second motor generator connected to the drive wheels via a reduction gear unit, respectively, and a parking-lock gear attached on the rotational shaft of the reduction gear unit and a parking-lock pole are mechanically engaged to lock the drive wheels of the vehicle (See FIG. 7A, FIG. 7B, FIG. 8A, and FIG. 8B).

Referring to FIG. 7A, FIG. 7B, FIG. 8A, and FIG. 8B, the three rotational elements of the drive power distribution mechanism are connected to an internal combustion engine (not shown in the drawings), to a first motor generator MG1 (not shown in the drawings), and to a second motor generator MG2 (not shown in the drawings) that is connected to a drive shaft 11 via a reduction gear unit 2.

Referring to FIG. 7A and FIG. 7B, a rotor shaft 10 of the motor generator MG2 is connected to the reduction-gear unit 2. The reduction-gear unit 2 is constituted of a sun gear S to which the drive power of the motor generator MG2 is input, a plurality of pinions P provided around the sun gear S, a carrier Ca having shaft portions Ca1 on which the respective pinions P are supported and projections Ca2 supported by respective fitting grooves 8a of a unit case 8 containing the drive power distribution mechanism, and a ring gear R provided around the pinions P and connected to the drive shaft 1 via which drive power is transmitted to drive wheels 3.

Parking-lock means 4 has a parking-lock pole 5 and a parking-lock cam 6 that is moved between a position where the parking-lock pole 5 is engaged with gear teeth R1 of the ring gear R and a position where the parking-lock pole 5 is disengaged from the gear teeth R1. According to the parking-lock means 4 thus structured, as the shift lever is shifted to the parking position, the parking-lock pole 5 engages with the ring gear R to lock the rotational elements of the reduction-gear unit 2 and thus lock the drive wheels 3 via the drive shaft 1. Then, as the shift position is shifted from the parking position to other position, the parking-lock pole 5 is disengaged from the ring gear R, thus allowing the rotational elements of the reduction-gear unit 2 to rotate and thus allowing the drive wheels 3 to rotate via the drive shaft 1.

When a vehicle incorporating the parking-lock device 4 is stopped on a hill, the vehicle may rock for the following reason.

Referring to FIG. 8A, when the driver shifts the shift lever to the parking position after stopping the vehicle on a hill by depressing the brake pedal, the parking-lock pole 5 engages with the ring gear R, that is, the parking-lock means 4 is turned on.

When the brake pedal is released after the parking-lock means 4 has been turned on as mentioned above, downward force corresponding to the weight of the vehicle acts on the vehicle due to the gradient of the hill. At this time, the drive shaft 1 connected to the drive wheels 3 is distorted with respect to the parking-lock means 4.

At this time, if the torsional torque at the drive shaft 1 is large, the drive shaft 1 kicks back due to its elasticity, causing the vehicle to rock back and forth until the torsional torque at the drive shaft 1 due to the weight of the vehicle and the elastic force of the drive shaft 1 reach an equilibrium. Such rocking of the vehicle may cause uncomfortable feeling of the occupants of the vehicle.

To avoid such rocking of the vehicle, for example, Japanese Patent Application Publication No. 2007-55354 (JP-A-2007-55354) describes a vehicle control apparatus that gradually reduces the braking force when the brake devices of the vehicle are turned off after the shift lever has been shifted to the parking position while the vehicle is stopped.

More specifically, if the shift lever is shifted to the parking position when the vehicle is stopped on a hill, the parking-lock means is activated. At this time, if the brake devices are turned off after the activation of the parking-lock means, because the braking force is gradually reduced, the downward force produced due to the weight of the vehicle is gradually transferred to the drive shaft.

Therefore, the torsional torque produced at the drive shaft due to the weight of the vehicle and the elastic force of the drive shaft gradually reach an equilibrium, and thus the vehicle does not rock back and forth, and thus the occupants of the vehicle do not feel uncomfortable.

According to the vehicle control apparatus described above, however, because only the gradual reduction of the braking force is performed when the brake devices are turned off after the shift lever has been shifted to the parking position while the vehicle is stopped, the torsional torque at the drive shaft may be transferred even to inertial objects having a large weight when the parking-lock pole is disengaged from the parking-lock gear in response to the shift lever being shifted from the parking position to other position after the brake devices have been turned off.

More specifically, referring to FIG. 8B, if the brake devices are turned on to disengage the parking-lock pole 5 from the ring gear R, the brake discs at the drive wheels 3 are locked by wheel cylinders 7, whereby the drive wheels 3 are locked.

If the parking-lock pole 5 is disengaged from the ring gear R in this state, the torsional force accumulated at the drive shaft 1 is rapidly released, so that the rotational elements of the reduction-gear unit 2 rotate fast due to the torsional energy of the drive shaft 1 with respect to the drive wheels 3.

In the hybrid vehicle described above, because the motor generator MG2, which is an inertial object having a large weight, is provided upstream of the reduction gear unit, due to the law of inertia, the motor generator MG2 does not immediately start rotating under the torsional force of the drive shaft 1, and therefore, at this time, the torsional torque of the drive shaft 1 travels from the drive shaft 1 to the motor generator MG2 via the reduction gear unit 2.

As the torsional force of the drive shaft 1 thus travels, the ring gear R, the pinions P, and the sun gear S rotate. At this time, if there are backlashes between the projections Ca2 of the carrier Ca and the fitting grooves 8a of the unit case 8 and there are backlashes between the ring gear R, the pinions P, and the sun gear S, their rotation speeds are accelerated as much as they rotate to eliminate said backlashes.

As such, a very large impact load that has been produced by the torsional energy of the drive shaft 1 and then intensified through the acceleration caused by the aforementioned backlashes is applied to the rotor shaft 10 (drive power input means) of the motor generator MG2 via the reduction-gear unit 2, making the occupants of the vehicle feel uncomfortable.

Meanwhile, as described above, the vehicle control apparatus described in JP-A-2007-55354 only controls the brake devices so as to reduce the braking force gradually when the brake devices are turned off after the shift lever has been shifted to the parking position while the vehicle is stopped. Therefore, when the braking force has become zero after the gradual reduction of the braking force, downward force occurs due to the weight of the vehicle. Thus, if the brake devices are turned on with the shift lever at the parking position, torsional torque is produced at the drive shaft, whereby impact load produced by the torsional torque of the drive shaft and intensified through the aforementioned acceleration due to the aforementioned backlashes is applied to the reduction gear unit.

On the other hand, Japanese Patent Application Publication 2003-247438 (JP-A-2003-247438) describes a vehicle control apparatus that drives, when the internal combustion engine is started, a motor generator to rotate the gears of parking-lock means in one direction with torque larger than the torque that is produced as reactive force at the drive shaft, thus preventing rattling noise from the meshed gears which may otherwise be caused by, for example, torque pulsation upon start of the internal combustion engine.

According to this vehicle control apparatus, that is, the backlashes between the motor generator and the parking-lock means are eliminated in advance by rotating the gears of the parking-lock means in one direction using the motor generator.

However, this vehicle control apparatus simply drives the motor generator to rotate the gears of the parking lock means in one direction regardless of whether the vehicle is on an uphill road or a downhill road despite the fact that the side on which the backlashes 9 are created differs depending upon whether the vehicle is on an uphill road or a downhill road as shown in FIG. 7A and FIG. 7B.

As such, in a case where the gears of the parking-lock means are simply rotated in one direction as in the case of JP-A-2003-247438, because the torsional direction of the drive shaft differs depending upon the direction of gradient of the road, the backlashes are expanded when the direction of gradient of the road on which the vehicle is presently located does not correspond to the direction in which the gears of the parking-lock means are rotated.

In this case, the speed at which the rotational elements of the reduction gear unit rotate under the torsional energy of the drive shaft is accelerated as much as they rotate to eliminate the expanded backlashes, resulting in an increase in the impact load applied to the rotor shaft of the motor generator via the reduction gear unit.

### SUMMARY OF THE INVENTION

The invention provides vehicle control apparatuses and vehicle control methods that minimize the impact that is applied to a drive power input portion when the parking-lock device is unlocked, thus eliminating the need for increasing the product durability that often results in an increase in the production cost and an increase in the weight of the product and preventing the occupants of the vehicle from feeling uncomfortable.

The first aspect of the invention relates to a vehicle control apparatus, having: a drive power input portion which is connected to a drive power source of the vehicle and to which drive power is input from the drive power source; a drive power transmission portion that transmits drive power from the drive power input portion to a drive shaft via a gear mechanism so that drive wheels coupled with the drive shaft rotate; a brake device that applies braking force corresponding to the operation amount of a brake pedal of the vehicle to the drive wheels; a parking-lock device provided at the gear mechanism and adapted to be set in a lock position where gears of the gear mechanism are locked to lock the drive wheels when the gear mechanism is shifted to a first shift position and to be set in an unlock position where the gears of the gear mechanism are unlocked to allow the drive wheels to rotate when the gear mechanism is shifted to a second shift position; a unit case containing the drive power input portion and the drive power transmission portion and supporting the gear mechanism; an operation state detection portion that detects an operation state of the brake device; a gradient detection portion that detects the gradient of a road on which the vehicle is presently located and detects the direction of the gradient of the road; a rotational torque generation portion that generates rotational torque in a normal direction or in a reverse direction with respect to the rotational direction of the gears of the gear mechanism; and a drive control portion that controls the rotational torque generation portion to generate rotational torque in a direction corresponding to the detected direction of the gradient of the road when the brake device is turned on while the gear mechanism is at the first shift position and the detected gradient of the road is equal to or larger than a predetermined gradient.

According to the vehicle control apparatus described above, in a case where, in order to stop the vehicle on a hill, the brake device is turned on and then the shift lever is shifted to the parking position (“P” position) to lock the parking-lock device and then the brake device is turned off and then the brake device is turned on despite that torsional torque is acting on the drive shaft, the rotational torque generation portion is driven to generate rotational torque in a direction corresponding to the detected direction of gradient of the road. This rotational torque is transmitted to the gear mechanism, whereby the backlashes between the parking-lock device and the drive power input portion, that is, the backlashes between the gears of the gear mechanism and the backlashes between the gear mechanism and the unit case are eliminated.

According to the vehicle control apparatus described above, that is, the impact load that is applied from the drive shaft to the drive power input portion via the gear mechanism when the parking-lock device is switched from the lock position to the unlock position can be reduced by the amount corresponding to the acceleration that would have been caused by the eliminated backlashes between the parking-lock device and the drive power input portion.

As such, the impact applied to the drive power input portion can be minimized, eliminating the need for increasing the product durability that often results in an increase in the production cost and an increase in the weight of the product and preventing the occupants of the vehicle from feeling uncomfortable.

The second aspect of the invention relates to a vehicle control method for a vehicle having: a drive power input portion which is connected to a drive power source of the vehicle and to which drive power is input from the drive power source; a drive power transmission portion that transmits drive power from the drive power input portion to a drive shaft via a gear mechanism so that drive wheels coupled with the drive shaft rotate; a brake device that applies braking force corresponding to the operation amount of a brake pedal of the vehicle to the drive wheels; a parking-lock device provided at the gear mechanism and adapted to be set in a lock position where gears of the gear mechanism are locked to lock the drive wheels when the gear mechanism is shifted to a first shift position and to be set in an unlock position where the gears of the gear mechanism are unlocked to allow the drive wheels to rotate when the gear mechanism is shifted to a second shift position ; and a rotational torque generation portion that generates rotational torque in a normal direction or in a reverse direction with respect to the rotational direction of the gears of the gear mechanism. This vehicle control method includes: detecting an operation state of the brake device; detecting the gradient of a road on which the vehicle is presently located and detecting the direction of the gradient of the road; and controlling the rotational torque generation portion to generate rotational torque in a direction corresponding to the detected direction of the gradient of the road when the brake device is turned on while the gear mechanism is at the first shift position and the detected gradient of the road is equal to or larger than a predetermined gradient.

Accordingly, the vehicle control apparatuses and methods of the invention minimize the impact that is applied to the drive power input portion when the parking-lock device is switched from the lock position to the unlock position, eliminating the need for increasing the product durability that often results in an increase in the production cost and an increase in the weight of the product and preventing the occupants of the vehicle from feeling uncomfortable.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a view schematically showing the configuration of a hybrid vehicle incorporating a vehicle control apparatus according to an example embodiment of the invention;

FIG. 2 is a cross-sectional view of a portion of a reduction-gear unit of the vehicle control apparatus according to the example embodiment of the invention;

FIG. 3A and FIG. 3B are cross-sectional views taken along line III-III in FIG. 2;

FIG. 4 is a view showing the structure of a portion of the vehicle control apparatus according to the example embodiment of the invention;

FIG. 5 is a flowchart illustrating a braking-force control routine executed in the vehicle control apparatus according to the example embodiment of the invention;

FIG. 6 is a graph indicating the impact load produced by torsional torque of a drive shaft and input from a motor generator to a unit case in response to a parking-lock device being unlocked in comparison between a case where there are backlashes between the parking-lock device and the motor generator and in a case where there are no such backlashes;

FIG. 7A and FIG. 7B are views showing the structure of a reduction-gear unit according to a related art; and

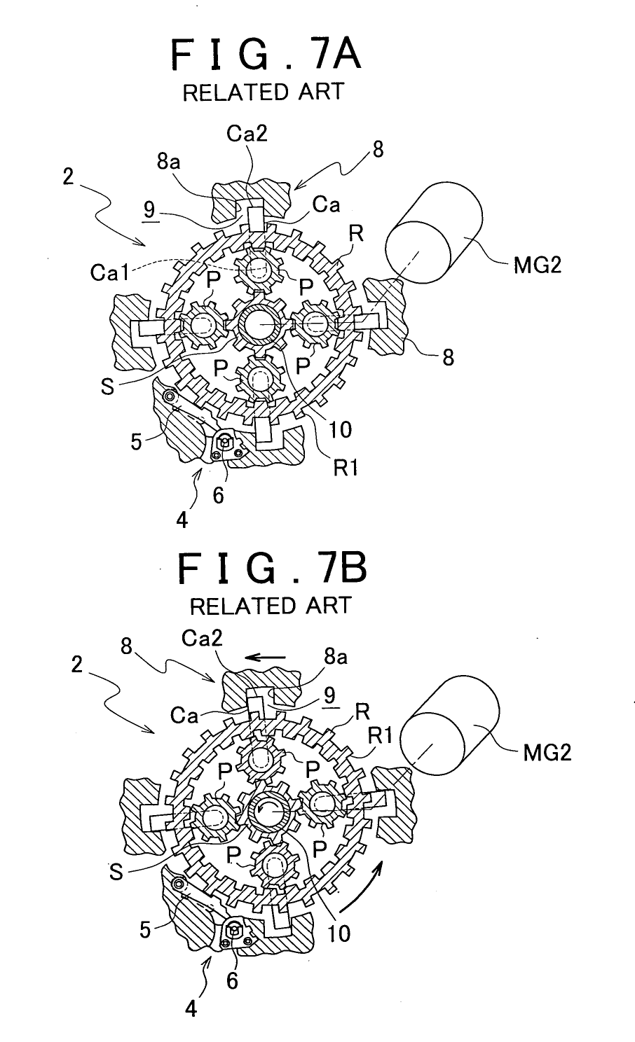

FIG. 8A is a view illustrating how torsional torque of the drive shaft is input to a drive power input portion when the brake devices are turned off after the parking-lock device is locked, and FIG. 8B is a view illustrating how torsional torque of the drive shaft is input to the drive power input portion when the brake devices are turned on after the parking-lock device is locked.

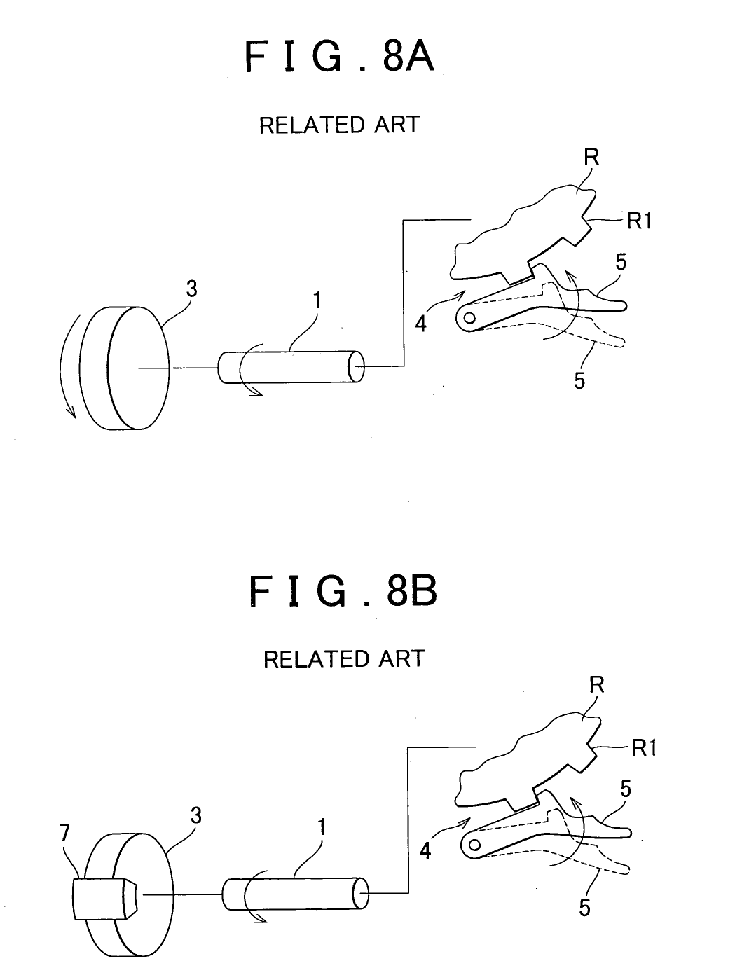

### DETAILED DESCRIPTION OF THE EMBODIMENTS

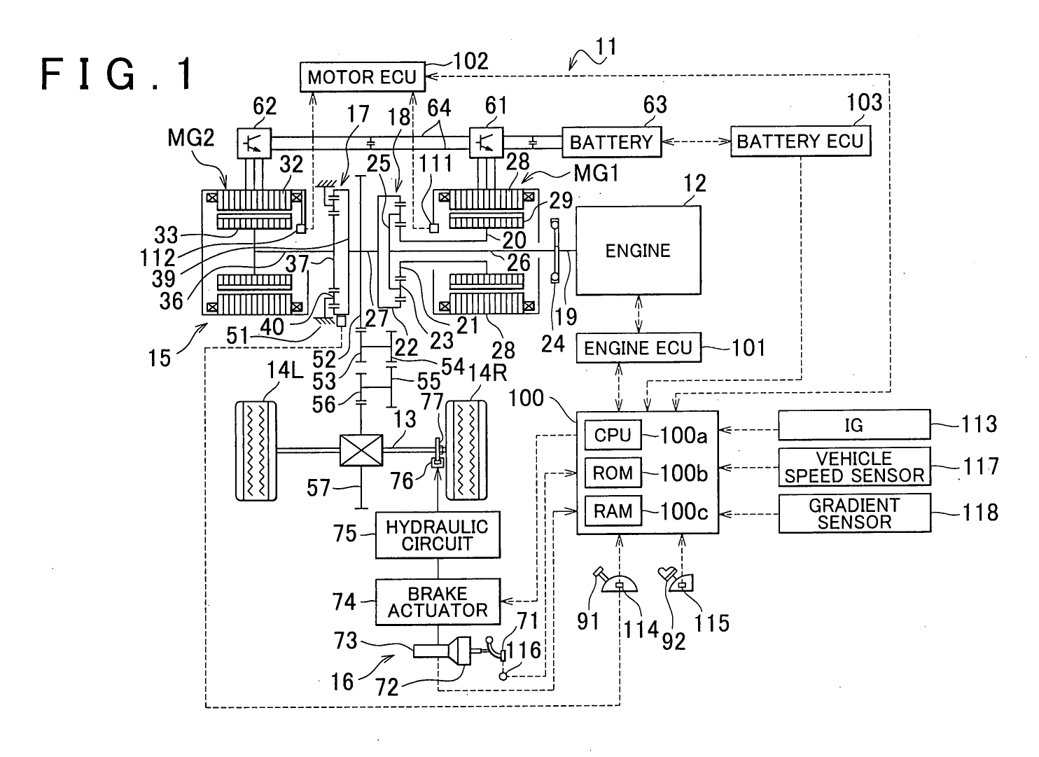

Hereinafter, vehicle control apparatuses according to example embodiments of the invention will be described with reference to the drawings. FIG. 1 to FIG. 6 are views illustrating a vehicle control apparatus according to an example embodiment of the invention. This vehicle control apparatus is incorporated in a hybrid vehicle.

First, the configuration of the vehicle control apparatus will be described. Referring to FIG. 1, a hybrid vehicle 11 has an engine 12 that is an internal combustion engine, a drive power distribution apparatus 15 that transmits the drive power of the engine 12 to drive wheels 14L, 14R via a driveshaft 13, a brake system 16 that applies braking force to the drive wheels 14L, 14R, and a hybrid vehicle electronic control unit 100 (will be referred to as “hybrid vehicle ECU”) that controls the overall operation of the hybrid vehicle 11.

The drive power distribution apparatus 15 has a motor generator MG1, a motor generator MG2, a reduction gear unit 17 connected to a rotor shaft 36 of the motor generator MG2, and a drive power distribution mechanism 18 that controls drive power distribution between the engine 12 and the motor generator MG1. The reduction gear unit 17 is adapted to establish, for example, a speed-reduction ratio of 2.0 or higher from the motor generator MG2 to the drive power distribution mechanism 18.

The engine 12 produces drive power from hydrocarbon fuel such as gasoline and light oil. An engine electronic control unit 101 (will hereinafter be referred to as “engine ECU”) is provided which receives the signals output from various sensors for detecting the operation conditions of the engine 12 and performs various engine operation controls including the fuel injection control, the ignition control, and the intake amount adjustment control.

The drive power distribution mechanism 18 involves a planetary gear mechanism constituted of a sun gear 21, a ring gear 22, pinions 23, and a carrier 25. The sun gear 21 is coupled with a sun-gear shaft 20 that is a hollow shaft having an axial hole. The crankshaft 19 extends through the axial hole of the sun-gear shaft 20. The ring gear 22 is supported rotatable coaxially with the crankshaft 19 and connected to the reduction gear unit 17 via a ring-gear shaft 27. The pinions 23 are provided between the sun gear 21 and the ring gear 22 and each rotate while revolving around the sun gear 21. The carrier 25 has an input shaft 26 coupled with one end of the crankshaft 19 via a damper 24. The rotational shafts of the pinions 23 are provided on the carrier 25. Thus structured, the drive power distribution mechanism 18 provides differential functions using the sun gear 21, the ring gear 22, and the pinions 23 as rotational elements.

According to the drive power distribution mechanism 18 structured as described above, when the motor generator MG1 is operating as a power generator, the drive power of the engine 12 input via the carrier 25 is distributed to the sun gear 21 and to the ring gear 22 according to the gear ratio therebetween, and on the other hand, when the motor generator MG1 is operating as a motor, the drive power of the engine 12 input via the carrier 25 and the drive power of the motor generator MG1 input via the sun gear 21 are combined and output to the ring gear 22.

The motor generator MG1 has a stator 28 that creates a rotational magnetic field and a rotor 29 provided in the stator 28 and incorporating a plurality of permanent magnets. The stator 28 has a stator core and a three-phase coil wounded around the stator core.

The rotor 29 is coupled with the sun-gear shaft 20 that rotates together with the sun gear 21 of the drive power distribution mechanism 18, and the stator core of the stator 28 is constituted of a plurality of laminated thin magnetic steel sheets and fixed on an inner peripheral face of a unit case, which will be described later. Thus, the motor generator MG1 is disposed in the unit case.

Structured described above, the motor generator MG1 operates as a motor that turns the rotor 29 through interactions between the magnetic fields created by the permanent magnets of the rotor 29 and the magnetic fields created by the three-phase coil of the stator 28, and the motor generator MG1 also operates as a power generator that produces electromotive forces at the both ends of the three-phase coil of the stator 28 through the interactions between the magnetic fields created by the permanent magnets of the rotor 29 and the rotation of the rotor 29.

The motor generator MG2 is constituted of a stator 32 that creates rotational magnetic fields and a rotor 33 provided in the stator 32 and incorporating a plurality of permanent magnets. The stator 32 has a stator core and a three-phase coil wound around the stator core.

A rotor shaft 36 of the rotor 33 is splined to the sun gear 37 of the reduction gear unit 17, and the stator core of the stator 32 is constituted of laminated thin magnetic steel sheets and fixed on an inner peripheral face of the unit case. Thus, the motor generator MG2 is disposed in the unit case.

Structured as described above, the motor generator MG2 operates as a power generator that produces electromotive forces at the both ends of the three-phase coil of the stator 32 through interactions between the magnetic fields created by the permanent magnets and the rotation of the rotor 33, and the motor generator MG2 operates also as a motor that turns the rotor 33 through interactions between the magnetic fields created by the permanent magnets and the magnetic fields created by the three-phase coil of the stator 32.

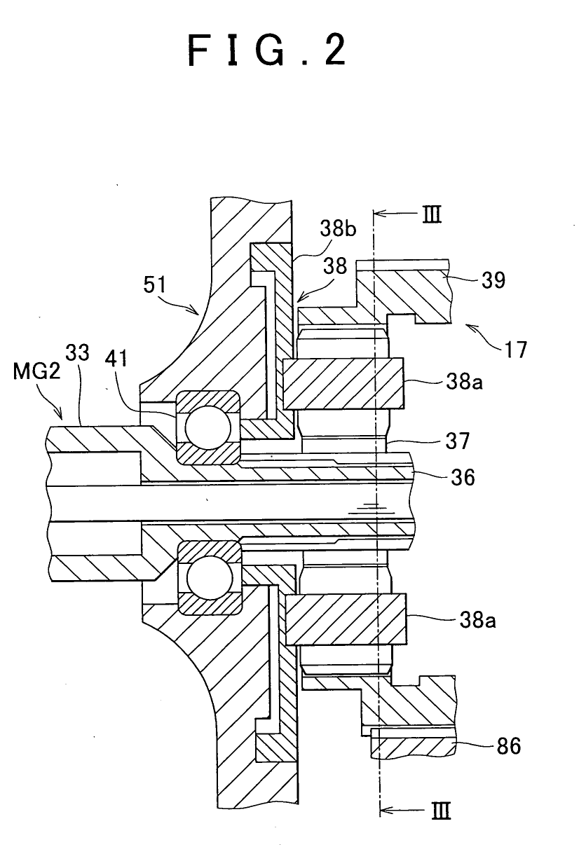

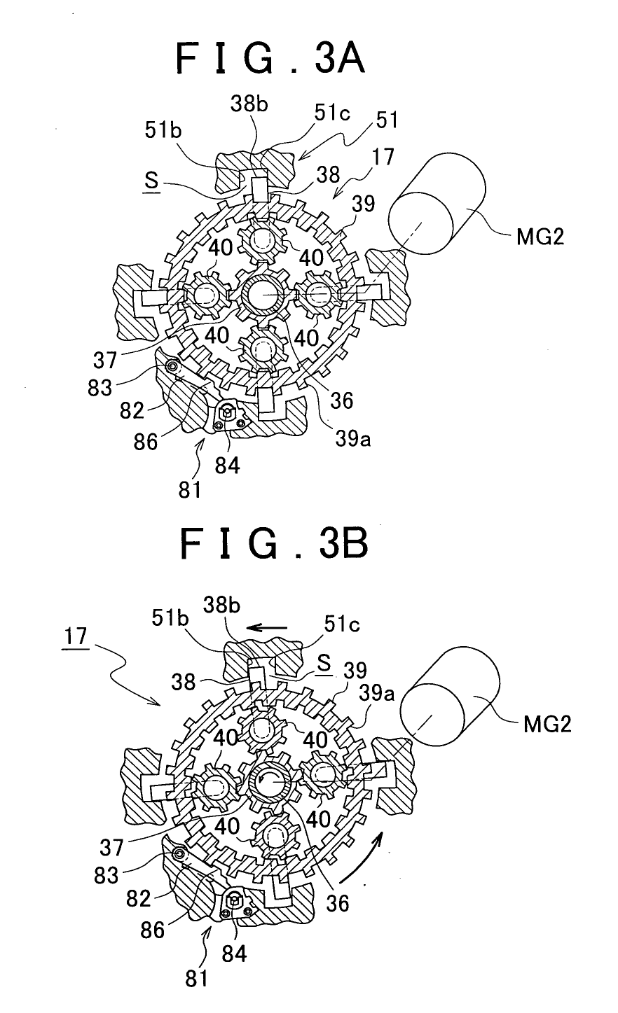

Referring to FIG. 2, in order to perform speed-reduction, the reduction gear unit 17 has a structure in which a carrier 38, which is one of the rotational elements of a planetary gearset, is fixed to the unit case of the drive power distribution apparatus 15. More specifically, referring to FIG. 2, FIG. 3A, and FIG. 3B, the reduction gear unit 17 is constituted of a sun gear 37 coupled with the rotor shaft 36, a ring gear 39 that rotates together with the ring gear 22 of the drive power distribution mechanism 18, pinions 40 meshed with the ring gear 39 and the sun gear 37 to transmit the rotation of the sun gear 37 to the ring gear 39, and a carrier 38 having support shafts 38a on which the respective pinions 40 are rotatably supported.

The speed-reduction ratio established at the reduction gear unit 17 is made 2.0 or higher by making the number of the gear teeth of the ring gear 39 twice or more the number of the gear teeth of the sun gear 37. The rotor shaft 36 is rotatably supported on the unit case 51 via a bearing 41.

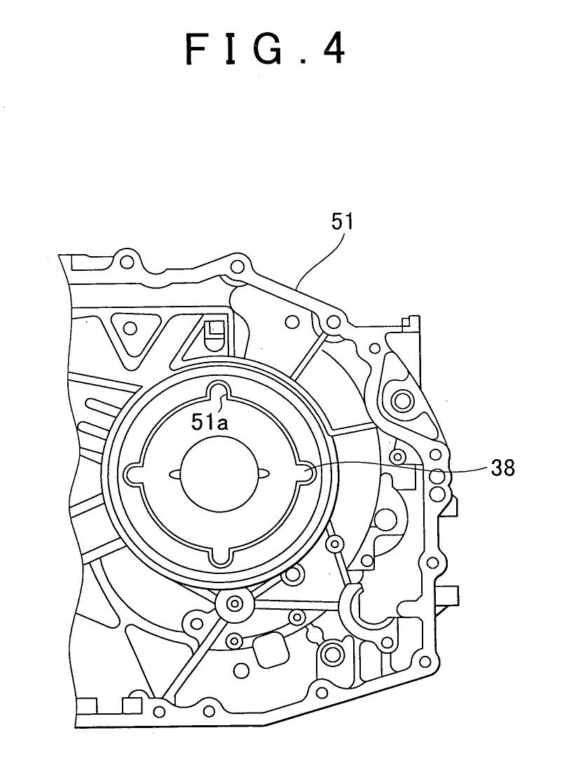

Referring to FIG. 4, multiple fitting grooves 51a are formed on the unit case 51 of the drive power distribution apparatus 15 so as to be spaced apart from each other in the circumferential direction of the carrier 38, while multiple projections 38b that fit in the respective fitting grooves 51a are provided on the outer peripheral face of the carrier 38. Although FIG. 3A, FIG. 3B, and FIG. 4 only show part of the unit case 51, the unit case 51 actually contains the drive power distribution mechanism 18, the motor generator MG1, the motor generator MG2, and a drive power transmission portion, which will be described later.

The reduction gear unit 17 is attached to the unit case 51 by the projections 38b of the carrier 38 being splined to the respective fitting grooves 51a. With the reduction gear unit 17 attached to the unit case 51, the projections 38b fit in the respective fitting grooves 51a in the circumferential direction of the carrier 38, whereby the carrier 38 is locked not to rotate. The width of each fitting groove 51a is larger than the width of each projection 38b so that the reduction gear unit 17 can be easily attached to the unit case 51. Thus, backlashes S are provided between the fitting grooves 51a and the projections 38b.

Referring to FIG. 1, a counter drive gear 52 is integrally provided on the ring-gear shaft 27 and the counter drive gear 52 rotates together with the ring-gear shaft 27. The counter drive gear 52 is meshed with the idle-drive gear 53, and the idle-drive gear 53 is coupled with a counter driven gear 55 via an idle driven gear 54.

The counter driven gear 55 is coupled with a differential gear 57 via a final gear 56. The differential gear 57 transmits drive torque to the drive wheels 14L, 14R via a drive shaft 13.

The motor generator MG1 and the motor generator MG2 supply electric power to and receive electric power from a battery 63 via inverters 61, 62, respectively, as needed.

An electric power line 64 is provided between the inverter 61 and the inverter 62, which is constituted of a positive bus and a negative bus shared by the inverters 61, 62 so that the electric power generated by one of the motor generators MG1, MG2 can be consumed by the other.

Thus, the battery 63 is charged with the electric power generated by the motor generator MG1 and/or the motor generator MG2 and discharges electric power to compensate for the shortage of electric power at the motor generator MG1 and/or at the motor generator MG2. Note that when the electric power balance between the motor generator MG1 and the motor generator MG2 is even, neither of the power charge nor the power discharge of the battery 63 is performed.

The motor generator MG1 and the motor generator MG2 are both controlled by a motor electronic control unit 102 (will hereinafter be referred to as “motor ECU”).

The motor ECU 102 receives various signals used for the drive control of the motor generator MG1 and the motor generator MG2, such as the signals output from a rotational position sensor 111 for detecting the rotational position of the rotor of the motor generator MG1 and a rotational position sensor 112 for detecting the rotational position of the rotor of the motor generator MG2 and the signals output from current sensors (not shown in the drawings) that detect the phase current supplied to the motor generator MG1 and to the motor generator MG2. The motor ECU 102 outputs switching signals to the inviters 61, 62.

The motor ECU 102 communicates with the hybrid vehicle ECU 100 and controls the motor generators MG1, MG2 according to the control signals output from the hybrid vehicle ECU 100 and provides, when necessary, the hybrid vehicle ECU 100 with the data regarding the operation conditions of the motor generators MG1, MG2.

The battery 63 is monitored by a battery electronic control unit 103 (will hereinafter be referred to as “battery ECU”). The battery ECU 103 receives various signals necessary for monitoring the battery 63, such as the signals output from a voltage sensor (not shown in the drawings) that is provided between the terminals of the battery 63 to detect the voltage between the terminals, the signals output from a current sensor (not shown in the drawings) that is provided on an electric power line 64 connected to the output terminal of the battery 63 to detect the current supplied to the battery 63 and the current discharged from the battery 63, and the signals output from a temperature sensor (not shown in the drawings) that is attached on the battery 63 to detect the temperature of the battery 63. The battery ECU 103 provides, when necessary, the hybrid vehicle ECU 100 with the data regarding the state of the battery 63. The battery ECU 103 calculates the SOC (State Of Charge) of the battery 63 by accumulating the value of current detected by the current sensor.

Meanwhile, the brake device 16 is constituted of a brake pedal 71, a brake booster 72, a master cylinder 73, a brake actuator 74, a hydraulic circuit 75, a brake mechanism 76, and a brake disc 77.

The brake disc 77 is provided at the drive wheel 14R side end of the drive shaft 13, and the brake mechanism 76 is provided at the brake disc 77. The brake mechanism 76 has a wheel cylinder that is actuated to cramp the brake disc 77 between brake pads.

The hydraulic circuit 75 is connected to one end of the brake mechanism 76. The hydraulic pressure applied to the wheel cylinder increases as the hydraulic pressure in the hydraulic circuit 75 increases, whereby the force with which the wheel cylinder cramps the brake disc 77 between the brake pads increases. Thus, the frictional force between the brake pads and the brake disc 77 increases, whereby the drive-wheels 14L, 14R are braked.

As such, as the hydraulic pressure at the brake mechanism 76 increases, braking force corresponding to the increase in the hydraulic pressure is produced at the hybrid vehicle 11. Meanwhile, although not shown in the drawings, brake mechanisms 76 and brake disks 77 are also provided at the drive wheels 14L and the driven wheels of the hybrid vehicle 11, respectively. The brake mechanisms 76 may alternatively be drum brake mechanisms provided directly on the drive wheels 14L, 14R, rather than disc brake mechanisms.

A master cylinder 73 is connected to the other end of the hydraulic circuit 75, and a piston (not shown in the drawings) is provided in the master cylinder 73. The hydraulic pressure in the master cylinder 73 increases as the piston moves, so that the hydraulic pressure in the hydraulic circuit 75 increases accordingly.

The brake booster 72 transmits the operation force applied to the brake pedal 71 to the master cylinder 73 after amplifying said force using the negative pressure produced at the intake side of the engine 12 during its operation.

The brake actuator 74 is provided between the master cylinder 73 and the hydraulic circuit 75 and has an electromagnetic valve and an electric pump. The electromagnetic valve and the electric pump of the brake actuator 74 are operated according to the control signals output from the hybrid vehicle ECU 100, so that the hydraulic pressure in the hydraulic circuit 75 increases or decreases as required. In this manner, the hydraulic pressure supplied to the brake mechanism 76 is adjusted, whereby the braking force applied to the drive wheels 14L, 14R is controlled. The hydraulic circuit 75 is formed by a liquid passage extending from the brake actuator 74 to the brake mechanism 76 and filled up with brake fluid.

Referring to FIG. 3A and FIG. 3B, the reduction gear unit 17 is provided with a parking-lock device 81. The ring gear 39 serves a parking lock gear of the parking-lock device 81. A parking-lock pole 82 meshes with gear teeth 39a formed in the outer peripheral face of the ring gear 39. A pivot support portion 83 at one end of the parking-lock pole 82 is supported on the unit case 51 so that the parking-lock pole 82 is pivotable in the vertical direction of FIG. 3 with respect to the pivot support portion 83.

The other end of the parking-lock pole 82 is in contact with a parking-lock cam 84, and the parking-lock pole 82 pivots up and down about the pivot support portion 83 as the parking-lock cam 84 rotates. An projection 86 is provided at the longitudinal center of the parking-lock pole 82 and it meshes with the gear teeth 39a.

The parking-lock cam 84 pivots to a position where it lifts up the other end of the parking-lock pole 82 as a shift lever, which will be described later, is shifted to the parking position (“P” position) (“first shift position”), and the parking-lock cam 84 pivots to a position where it lifts down the other end of the parking-lock pole 82 as the shift lever is shifted to the reverse position (“R” position), to the neutral position (“N” position”), or to the drive position (“D” position) (“second shift position”). The parking-lock cam 84 may either be structured to be mechanically interlocked with the shift lever or structured to be driven by an electric motor.

Thus, the rotation of the ring gear 39 is stopped as the parking-lock cam 84 brings the projection 86 of the parking-lock pole 82 to the position where the projection 86 meshes with the gear teeth 39a of the ring gear 39, and as a result, the rotational elements on the drive power transmission path from the ring gear 39 to the drive shaft 13 are locked, whereby the drive wheel 14L, 14R are locked.

When the projection 86 of the parking-lock pole 82 is disengaged from the gear teeth 39a of the ring gear 39 through the driving of the parking-lock cam 84, the ring gear 39 is allowed to rotate, so that the rotational elements on the drive power transmission path from the ring gear 39 to the drive shaft 13 are allowed to rotate, and so are the drive wheels 14L, 14R.

In this example embodiment of the invention, the motor generator MG2 serves as “drive power source”, and the rotor shaft 36 of the motor generator MG2 serves as “drive power input portion”, and the reduction gear unit 17, the counter drive gear 52, the idle-drive gear 53, the idle-driven gear 54, the counter-driven gear 55, the final gear 56, and the differential gear 57 together serve as “drive power transmission portion”.

Further, in the example embodiment of the invention, the reduction gear unit 17, the counter drive gear 52, the idle-drive gear 53, the idle-driven gear 54, the counter driven gear 55, the final gear 56, and the differential gear 57 together serve as “gear mechanism”.

Meanwhile, referring to FIG. 1, the hybrid vehicle ECU 100 is constituted of a microprocessor including a CPU (Central Processing Unit) 100a as the main component, a ROM (Read Only Memory) 100b for storing various operation and control programs, a RAM (Random Access Memory) 100c for temporarily storing various data, an input port (not shown in the drawings), an output port (not shown in the drawings), and a communication port (not shown in the drawings).

The hybrid vehicle ECU 100 receives, via the input port, various signals including: ignition signals Ig output from an ignition switch (IG) 113; shift position signals SP output from a shift position sensor 114 for detecting the shift position of a shift lever 91 that is manually operated by the driver, accelerator operation amount signals Acc output from an accelerator pedal position sensor 115 for detecting the travel of an accelerator pedal 92 depressed by the driver; brake pedal position signals BP output from a brake pedal position sensor 116 for detecting the travel of the brake pedal 71; vehicle speed signals V output from the vehicle speed sensor 117; and gradient angle signals Gx output from a gradient sensor 118 for detecting the gradient of the road on which the hybrid vehicle 11 is presently located.

The gradient sensor 118 is, for example, a G-sensor. The gradient sensor 118 has a spindle supported such that it rocks in the longitudinal direction of the hybrid vehicle 11. The gradient sensor 118 outputs, when the vehicle is not moving, the gradient angle signals Gx indicating the displacement of the spindle which corresponds to the longitudinal inclination of the vehicle with respect to a reference axis perpendicular to the road surface.

For example, the gradient sensor 118 outputs positive gradient angle signals Gx when the hybrid vehicle 11 is stopped on an uphill road, and outputs negative gradient angle signals Gx when the hybrid vehicle 11 is stopped on a downhill road. Further, the larger the gradient of the road, the larger the absolute values of the positive and negative gradient signals Gx. When the hybrid vehicle 11 is stopped on an uphill road, downward force acting toward the rear of the hybrid vehicle 11 occurs due to the weight of the hybrid vehicle 11, and on the other hand, when the hybrid vehicle 11 is stopped on a downhill road, downward force acting toward the front of the hybrid vehicle 11 occurs due to the weight of the hybrid vehicle 11.

The hybrid vehicle ECU 100 calculates the gradient of the road, that is, the angle of gradient of the road, based on the gradient angle signals Gx. Note that in this example embodiment of the invention the gradient sensor 118 serves as “gradient detection portion” for detecting the gradient of the road on which the hybrid vehicle 11 is presently located.

The brake pedal position sensor 116 detects the travel of the brake pedal 71 (the depression of the brake pedal 71) and outputs the brake pedal position signals BP corresponding to the depression of the brake pedal 71 to the hybrid vehicle ECU 100. The hybrid vehicle ECU 100 determines the operation state of the brake device 16 by determining whether the brake device 16 is presently depressed or not and detecting the depression of the brake pedal 71 based on the brake pedal position signals BP input from the brake pedal position sensor 116. Note that in this example embodiment of the invention the brake pedal position sensor 116 serves as “operation state detection portion”.

A stop-lamp switch may be provided in place of the brake pedal position sensor 116 to detect whether the brake pedal 71 is presently depressed.

In this example embodiment of the invention, the hybrid vehicle ECU 100 is adapted to drive the motor generator MG2 to rotate in the direction corresponding to the direction of gradient of the road if the gradient of the road is equal to or larger than a predetermined gradient when the brake device 16 is activated while the shift lever 91 at the parking position (“P” position).

More specifically, when it is determined based on the information obtained from the shift position sensor 114 and the brake pedal position sensor 116 that the brake device 16 has been activated with the shift lever 91 at the parking position (“P” position), the hybrid vehicle ECU 100 determines the direction of gradient of the road and outputs to the motor ECU 102 the control signals for driving the motor generator MG2 to rotate in the normal or reverse direction on the condition that the gradient of the road is equal to or larger than the predetermined gradient.

Then, in response to the control signals input from the hybrid vehicle ECU 100, the motor ECU 102 controls the inverters 61, 62 to drive the rotor 33 of the motor generator MG2 to rotate in the normal or reverse direction.

As the motor generator MG2 thus rotates, rotational torque is applied from the rotor shaft 36 of the motor generator MG2 to the sun gear 37, and thus the rotational torque is transmitted from the sun gear 37 to the pinions 40 and then to the ring gear 39, whereby the backlashes between the sun gear 37, the pinions gears 40, and the ring gear 39 are eliminated.

At this time, each projection 38b of the carrier 38 is pressed against an inner face 51b or an inner face 51c of the corresponding fitting groove 51a of the unit case 51, whereby each backlash S between the projection 38b and the fitting groove 51a is eliminated.

The direction in which each projection 38b of the carrier 38 is pressed against the corresponding fitting groove 51a of the unit case 51 coincides with the direction in which the rotational elements of the reduction gear unit 17 rotate fast to eliminate the backlashes S under the torsional torque of the drive shaft 13 in response to the parking-lock device 81 being unlocked.

Because the direction in which the torsional torque of the drive shaft 13 acts depends on the direction of gradient of the road, the relation between the direction of road gradient and the direction in which the rotor 33 of the motor generator MG2 is rotated to eliminate the aforementioned backlashes is empirically determined and the determined relation is stored in the ROM 100b. Thus, the hybrid vehicle ECU 100 determines the rotation direction of the rotor 33 of the motor generator MG2 based on the road gradient detected by the gradient sensor 118 and drives the motor generator MG2 to rotate in the determined direction.

It is to be noted that in this example embodiment of the invention, the motor generator MG2, the motor ECU 102, the inverter 61, and the inverter 62 together serve as “rotational torque generation portion” and the hybrid vehicle ECU 100 serves as “drive control portion”.

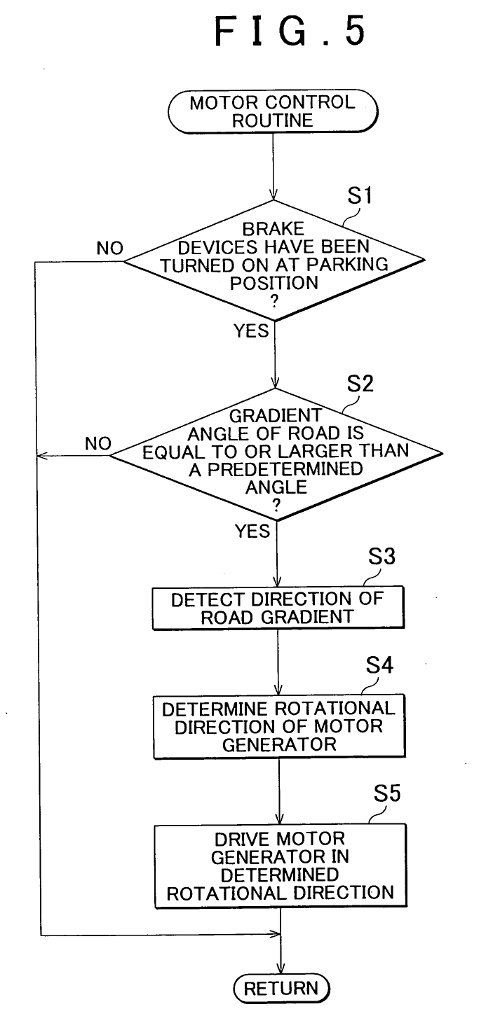

Next, the method for controlling the hybrid vehicle 11 will be described with reference to the flowchart of FIG. 5. The flowchart of FIG. 5 illustrates a motor control program executed by the CPU 100a of the hybrid vehicle ECU 100. This program is stored in the ROM 100b.

When stopping the hybrid vehicle 11 on a hill, the brake pedal 71 is depressed and then the shift lever 91 is shifted to the parking position (“P” position). At this time, the parking-lock cam 84 rotates to the position it lifts up the other end of the parking-lock pole 82, whereby the projection 86 of the parking-lock pole 82 engages with the gear teeth 39a of the ring gear 39, thereby locking the ring gear 39. Thus, the rotational elements on the drive power transmission path from the ring gear 39 to the drive shaft 13 are locked, whereby the drive wheels 14L, 14R are locked.

If the brake pedal 71 is released in this state, downward force corresponding to the weight of the hybrid vehicle 11 acts on the hybrid vehicle 11 due to the gradient of the road, distorting the drive shaft 13 with respect to the engagement point between the projection 86 and the gear teeth 39a.

If the amount of distortion of the drive shaft 13 is large, the drive shaft 13 kicks back due to its elasticity. In this case, the hybrid vehicle 11 may rock back and forth until the torsional torque produced at the drive shaft 13 due to the weight of the hybrid vehicle 11 and the elastic force of the drive shaft 13 reach an equilibrium.

At this time, if the brake device 16 is turned on to remove the shift lever 91 from the parking position, the wheel cylinders of the respective brake mechanisms 76 lock the brake discs 77 at the drive wheels 14L. 14R.

If the projection 86 of the parking-lock pole 82 is disengaged from the gear teeth 39a of the ring gear 39 in this state, the torsional energy accumulated at the drive shaft 13 is rapidly released with respect to the brake discs 77 and the wheels cylinders of the brake mechanisms 76, and the released torsional energy causes the rotational elements of the reduction gear unit 17 to rotate. At this time, due to the presence of the backlashes S between the projections 38b of the carrier 38 and the fitting grooves 51a of the unit case 51 and the backlashes between the ring gear 39, the pinions 40, and the sun gear 37, the rotation speed of the rotational elements of the reduction gear unit 17 is accelerated as much as they rotate to eliminate said backlashes. As a result, impact load is applied from the drive shaft 13 to the rotor shaft 36 of the motor generator MG2 via the reduction gear unit 17.

In view of the above, in this example embodiment of the invention, the motor control program illustrated in FIG. 5 is executed to prevent such application of impact load from the drive shaft 13 to the rotor shaft 36 of the motor generator MG2 via the reduction gear unit 17.

Referring to FIG. 5, the CPU 100a first determines whether the brake device 16 has been turned on by the brake pedal 71 being depressed with the shift lever 91 at the parking position (step S1).

In this step, more specifically, the CPU 100a determines the shift lever 91 to be presently at the parking position if the shift position signals SP indicating that the shift lever 91 has been shifted to the parking position have been input from the shift position sensor 114, and the CPU 100a determines the brake device 16 to have been turned on if the brake pedal position signals BP indicating that the brake pedal 71 has been turned on have been input from the brake pedal position sensor 116.

Subsequently, the CPU 100a determines based on the gradient angle signals Gx input from the gradient sensor 118 whether the gradient angle of the road on which the hybrid vehicle 11 is presently located is equal to or larger than a predetermined angle (e.g., 10°) (step S2).

If it is determined that the gradient angle of the road is equal to or larger than the predetermined angle, the hybrid vehicle ECU 100 then determines the direction of the gradient of the road based on the information detected by the gradient sensor 118 (step S3).

In this step, more specifically, if the gradient angle signals Gx input from the gradient sensor 118 are positive, the CPU 100a determines that the hybrid vehicle 11 is presently located on an uphill road, and on the other hand, if the gradient angle signals Gx are negative, the CPU 100a determines that the hybrid vehicle 11 is presently located on a downhill road.

Then, the CPU 100a determines the direction in which to turn the rotational elements of the reduction gear unit 17 to eliminate the aforementioned backlashes in the reduction gear unit 17 (step S4). Referring to FIG. 3, if it is assumed for descriptive convenience that the drive wheels 14L, 14R and the sun gear 37 rotate in the same direction, if the parking-lock device 81 is unlocked when the hybrid vehicle 11 is stopped on an uphill road, downward force acts toward the rear of the hybrid vehicle 11 due to the weight of the hybrid vehicle 11, and therefore counterclockwise torsional torque occurs at the drive shaft 13.

If the projection 86 of the parking-lock pole 82 is disengaged from the gear teeth 39a of the ring gear 39 when the backlashes S are between the inner faces 51b of the respective fitting grooves 51a of the unit case 51 and the projections 38b of the carrier 38 as shown in FIG. 3A, the torsional energy accumulated at the drive shaft 13 with respect to the brake discs 77 and the wheels cylinders of the brake mechanisms 76 is rapidly released, and the released torsional energy causes the rotational elements of the reduction gear unit 17 to rotate. At this time, due to the presence of the backlashes S between the projections 38b of the carrier 38 and the fitting grooves 51a of the unit case 51 and the backlashes between the ring gear 39, the pinions 40, and the sun gear 37, the rotation speed of the rotational elements of the reduction gear unit 17 is accelerated as much as they rotate to eliminate said backlashes. As a result, impact load is applied from the drive shaft 13 to the rotor shaft 36 of the motor generator MG2 via the reduction gear unit 17.

To counter this, in the motor control program in FIG. 5, after determining the rotational direction of the rotational elements of the reduction gear unit 17 in step S4 as described above, the CPU 100a then drives the motor generator MG2 in the direction corresponding to the determined rotational direction (step S5). That is, the CPU 100a transmits to the motor ECU 102 the control signals for driving the motor generator MG2 to rotate in the reverse direction. In response to the control signals from the CPU 100a, the motor ECU 102 controls the inverters 61, 62 such that the rotor 33 of the motor generator MG2 rotates counterclockwise.

As the rotor shaft 36 of the motor generator MG2 thus rotates, rotational torque is applied from the rotor shaft 36 of the motor generator MG2 to the sun gear 37. Thus, the rotational torque is transferred from the sun gear 37 to the pinions 40 and then to the ring gear 39 with respect to the engaging point between the projection 86 of the parking-lock pole 82 and the gear teeth 39a of the ring gear 39.

Thus, as shown in FIG. 3B, the projections 38b of the carrier 38 are pressed against the inner faces 51b of the respective fitting grooves 51a of the unit case 51, whereby the backlashes S between the projections 38b and the inner faces 51b of the fitting grooves 51a are eliminated, and further, the backlashes between the sun gear 37, the pinions 40, and the ring gear 39 are eliminated.

According to the example embodiment of the invention, as such, the impact load that is applied from the drive shaft 13 to the rotor shaft 36 of the motor generator MG2 via the reduction gear unit 17 when the projection 86 of the parking-lock pole 82 is disengaged from the gear teeth 39a of the ring gear 39 while the hybrid vehicle 11 is stopped on an uphill road can be reduced by the amount corresponding to the acceleration that would have been caused by the eliminated backlashes between the parking-lock device 81 and the rotor shaft 36 of the motor generator MG2.

On the other hand, if the parking-lock device 81 is unlocked when the hybrid vehicle 11 is stopped on a downhill road, downward force acts toward the front of the hybrid vehicle 11 due to the weight of the hybrid vehicle 11, and therefore clockwise torsional force occurs at the drive shaft 13.

At this time, if the projection 86 of the parking-lock pole 82 is disengaged from the gear teeth 39a of the ring gear 39 despite that the backlashes S are between the inner faces 51c of the respective fitting grooves 51a of the unit case 51 and the projections 38b of the carrier 38 as shown in FIG. 3B, the torsional energy accumulated at the drive shaft 13 with respect to the brake discs 77 and the wheels cylinders of the brake mechanisms 76 is rapidly released, and the released torsional energy causes the rotational elements of the reduction gear unit 17 to rotate. At this time, due to the presence of the backlashes S between the projections 38b of the carrier 38 and the fitting grooves 51a of the unit case 51 and the backlashes between the ring gear 39, the pinions 40, and the sun gear 37, the rotation speed of the rotational elements of the reduction gear unit 17 is accelerated as much as they rotate to eliminate said backlashes. As a result, impact load is applied from the drive shaft 13 to the rotor shaft 36 of the motor generator MG2 via the reduction gear unit 17.

To counter this, in the motor control program in FIG. 5, after determining the rotational direction of the rotational elements of the reduction gear unit 17 in step S4 as described above, the CPU 100a then drives the motor generator MG2 in the direction corresponding to the determined rotational direction (step S5). That is, the CPU 100a transmits to the motor ECU 102 the control signals for driving the motor generator MG2 to rotate in the normal direction. In response to the control signals from the CPU 100a, the motor ECU 102 controls the inverters 61, 62 such that the rotor 33 of the motor generator MG2 rotates clockwise.

As the rotor shaft 36 of the motor generator MG2 thus rotates, rotational torque is applied from the rotor shaft 36 of the motor generator MG2 to the sun gear 37. Thus, the rotational torque is transferred from the sun gear 37 to the pinions 40 and then to the ring gear 39 with respect to the engaging point between the projection 86 of the parking-lock pole 82 and the gear teeth 39a of the ring gear 39.

Thus, as shown in FIG. 3A, the projections 38b of the carrier 38 are pressed against the inner faces 51c of the respective fitting grooves 51a of the unit case 51, whereby the backlashes S between the projections 38b and the inner faces 51c of the fitting grooves 51a are eliminated, and further, the backlashes between the sun gear 37, the pinions 40, and the ring gear 39 are eliminated.

According to the example embodiment of the invention, as such, the impact load that is applied from the drive shaft 13 to the rotor shaft 36 of the motor generator MG2 via the reduction gear unit 17 when the projection 86 of the parking-lock pole 82 is disengaged from the gear teeth 39a of the ring gear 39 while the hybrid vehicle 11 is stopped on a downhill road can be reduced by the amount corresponding to the acceleration that would have been caused by the eliminated backlashes between the parking-lock device 81 and the rotor shaft 36 of the motor generator MG2.

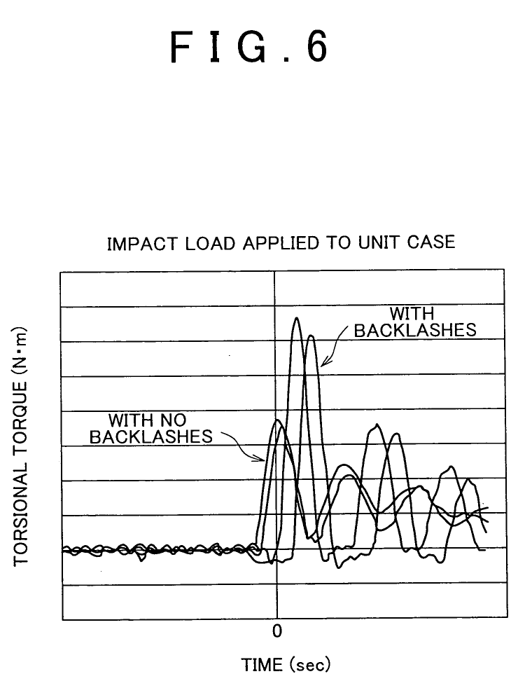

The graph of FIG. 6 shows the result of measurement of the impact load caused by the torsional torque of the drive shaft 13 that is input from the rotor shaft 36 of the motor generator MG2 to the unit case 51 when the parking-lock device 81 is unlocked (time 0). As shown in the graph, it was found that the impact load measured when the aforementioned backlashes were not between the parking-lock device 81 and the rotor shaft 36 of the motor generator MG2 was significantly lower than the impact load measured when the aforementioned backlashes were between the parking-lock device 81 and the rotor shaft 36 of the motor generator MG2.

As such, in the example embodiment of the invention, when the brake devices 16 have been turned on in the presence of torsional torque at the drive shaft 13 after the brake devices 16 were turned on to stop the hybrid vehicle 11 on an uphill road or a downhill road and then turned off after the shift lever 91 is shifted to the parking position (“P” position) to lock the parking-lock device 81, the motor generator MG2, which is an inertial object having a large weight, is driven to rotate in the rotational direction corresponding to the direction of gradient of the road, whereby rotational torque is applied from the motor generator MG2 to the sun gear 37, to the pinions 40, and to the ring gear 39. As such, backlashes that may be created between the parking-lock device 81 and the rotor shaft 36 of the motor generator MG2 depending upon the direction of gradient of the road, that is, the backlashes between the sun gear 37, the pinions 40, and the ring gear 39 and the backlashes between the carrier 38 and the unit case 51 are eliminated.

As such, the impact load that is applied from the drive shaft 13 to the rotor shaft 36 of the motor generator MG2 via the reduction gear unit 17 when the parking-lock device 81 is unlocked while the hybrid vehicle 11 is stopped on an uphill road or a downhill road can be reduced by the amount corresponding to the acceleration that would have been caused by the eliminated backlashes between the parking-lock device 81 and the rotor shaft 36 of the motor generator MG2.

Thus, the impact applied to the rotor shaft 36 of the motor generator MG2, the bearing 41 supporting the rotor shaft 36, and so on, via the reduction gear unit 17 can be suppressed, eliminating the need for increasing the product durability that often results in an increase in the production cost and an increase in the weight of the product and preventing the occupants of the vehicle from feeling uncomfortable.

According to the example embodiment of the invention, further, because the motor generator MG2 is used to apply rotational toque to the sun gear 37, the aforementioned backlashes between the parking-lock device 81 and the rotor shaft 36 of the motor generator MG2 can be eliminated without providing any additional part and component, and therefore the number of parts and components of the hybrid vehicle 11 does not increase and thus the production cost of the hybrid vehicle 11 does not increase.

While the invention has been embodied as the vehicle control apparatus incorporated in the hybrid vehicle 11 having the drive power distribution apparatus 15 having the motor generators MG1, MG2 in the foregoing example embodiment, the invention is not limited to this application.

For example, the invention may be embodied as a vehicle control apparatus for a vehicle incorporating a continuously variable transmission (CVT). In this case, for example, the drive power input portion that receives the drive power of the engine (drive power source) is constituted of a primary pulley and a secondary pulley that are connected to each other via a belt wound around the pulleys. The primary pulley and the secondary pulley are both an inertial object having a large weight. A parking-lock device is provided at a gear mechanism provided between the secondary pulley and the drive shaft, and, for example, a motor is provided at the gear mechanism and is used to apply rotational torque to the gear mechanism in the rotational direction corresponding to the direction of gradient of the road. If the control procedure of the invention is applied to this system, the impact applied from the drive shaft to the secondary pulley via the gear mechanism can be suppressed.

Further, in a case where the invention is embodied as a vehicle control apparatus for a vehicle incorporating a manual transmission, the drive power input portion that receives the drive power of the engine (drive power source) is constituted of a dry clutch, which is an inertial object having a large weight, and a parking-lock device is provided at a gear mechanism provided between the dry clutch and the drive shaft, and, for example, a motor is provided at the gear mechanism and is used to apply rotational torque to the gear mechanism in the rotational direction corresponding to the direction of gradient of the road. If the control procedure of the invention is applied to this system, the impact applied from the drive shaft to the dry clutch via the gear mechanism can be suppressed.

Further, in a case where the invention is embodied as a vehicle control apparatus for a vehicle incorporating an automatic transmission, the drive power input portion that receives the drive power of the engine (drive power source) is constituted of a fluid coupling, and the like, which is an inertial object having a large weight, and a parking-lock device is provided at a gear mechanism provided between the fluid coupling and the drive shaft, and, for example, a motor is provided at the gear mechanism and is used to apply rotational torque to the gear mechanism in the rotational direction corresponding to the direction of gradient of the road. If the control procedure of the invention is applied to this system, the impact applied from the drive shaft to the fluid coupling via the gear mechanism can be suppressed. Further, while the shift position is changed by shifting the shift lever mechanically connected to the shift selection portion of the transmission in the foregoing example embodiment, the shift position may alternatively be changed by using a switch, a lever, or the like, which is electrically connected to the shift selection portion of the transmission.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

As described above, the vehicle control apparatus of the invention is capable of minimizing the impact applied to the drive power input portion when the parking-lock device is unlocked, eliminating the need for increasing the product durability that often results in an increase in the production cost and an increase in the weight of the product and preventing the occupants of the vehicle from feeling uncomfortable. Therefore, the invention can be advantageously embodied as, for example, a control apparatus for a vehicle having a parking-lock device having a lock position where it locks the drive wheels and an unlock position where it allows the drive wheels to rotate.

What is claimed is:

1. A vehicle control apparatus, comprising:
a drive power input portion which is connected to a drive power source of the vehicle and to which drive power is input from the drive power source;
a drive power transmission portion that transmits drive power from the drive power input portion to a drive shaft via a gear mechanism so that drive wheels coupled with the drive shaft rotate;
a brake device that applies braking force corresponding to an operation amount of a brake pedal of the vehicle to the drive wheels;
a parking-lock device provided at the gear mechanism and adapted to be set in a lock position where gears of the gear mechanism are locked to lock the drive wheels when the gear mechanism is shifted to a first shift position and to be set in an unlock position where the gears of the gear mechanism are unlocked to allow the drive wheels to rotate when the gear mechanism is shifted to a second shift position;
a unit case containing the drive power input portion and the drive power transmission portion and supporting the gear mechanism;
an operation state detection portion that detects an operation state of the brake device;
a gradient detection portion that detects the gradient of a road on which the vehicle is presently located and detects the direction of the gradient of the road;
a rotational torque generation portion that generates rotational torque in a normal direction or in a reverse direction with respect to the rotational direction of the gears of the gear mechanism; and
a drive control portion that controls the rotational torque generation portion to generate rotational torque in a direction corresponding to the detected direction of the gradient of the road when the brake device is turned on while the gear mechanism is at the first shift position and the detected gradient of the road is equal to or larger than a predetermined gradient.

2. The vehicle control apparatus according to claim 1, wherein:
the rotational torque generation portion is constituted of a motor generator;
the gear mechanism is a planetary gearset having a sun gear, pinions provided around the sun gear, a carrier supporting the pinions and supported by the unit case, and a ring gear provided around the pinions and drivingly connected to the drive wheels;
a rotator shaft of the motor generator is coupled with the sun gear; and
the parking-lock device has a parking gear pole that is moved between a lock position where the parking gear pole is engaged with gear teeth at the outer periphery of the ring gear and an unlock position where the parking gear pole is disengaged from the gear teeth.

3. The vehicle control apparatus according to claim 1, wherein:
when the brake device is turned on while the gear mechanism is at the first shift position and the detected gradient of the road is equal to or larger than the predetermined gradient, the drive control portion controls the rotational torque generation portion to generate rotational torque in the same direction as the direction in which the gears of the gear mechanism rotate in response to the parking lock portion being switched from the lock position to the unlock position.

4. A vehicle control method for a vehicle having: a drive power input portion which is connected to a drive power source of the vehicle and to which drive power is input from the drive power source; a drive power transmission portion that transmits drive power from the drive power input portion to a drive shaft via a gear mechanism so that drive wheels coupled with the drive shaft rotate; a brake device that applies braking force corresponding to an operation amount of a brake pedal of the vehicle to the drive wheels; a parking-lock device provided at the gear mechanism and adapted to be set in a lock position where gears of the gear mechanism are locked to lock the drive wheels when the gear mechanism is shifted to a first shift position and to be set in an unlock position where the gears of the gear mechanism are unlocked to allow the drive wheels to rotate when the gear mechanism is shifted to a second shift position; and a rotational torque generation portion that generates rotational torque in a normal direction or in a reverse direction with respect to the rotational direction of the gears of the gear mechanism, the vehicle control method comprising:
detecting an operation state of the brake device;
detecting the gradient of a road on which the vehicle is presently located and detecting the direction of the gradient of the road; and
controlling the rotational torque generation portion to generate rotational torque in a direction corresponding to the detected direction of the gradient of the road when the brake device is turned on while the gear mechanism is at the first shift position and the detected gradient of the road is equal to or larger than a predetermined gradient.
